(19) United States
(12) Patent Application Publication
(10) Pub. No.: US 2018/0356231 A1
(43) Pub. Date: Dec. 13, 2018

(54) Fog Safety System and Method

(71) Applicant: Wartsila North America, Inc., Houston, TX (US)

(72) Inventors: Heink Steffens, Emden (DE); Claus Oltrogge, Emden (DE); Andreas Kohler, Emden (DE); Richard Dixon, Colhester (GB); Christian Sellin, Hamburg (DE)

(73) Assignee: Wartsila North America, Inc., Houston, TX (US)

(21) Appl. No.: 15/906,342

(22) Filed: Feb. 27, 2018

Related U.S. Application Data
(60) Provisional application No. 62/464,479, filed on Feb. 28, 2017.

(51) Int. Cl. G01C 21/00; G01N 21/49; G01N 21/21; G01W 1/14; G05D 1/02; G08G 3/02

(52) U.S. Cl. CPC G01C 21/005; G01N 21/49; G01N 21/21; B63J 2099/008; G05D 1/0206; G08G 3/02; G01W 1/14

(57) ABSTRACT

Systems and methods for displaying a communication from a vessel in a first location to a person or second vessel in a second location are described. The communication system alerts persons and other nearby vessels to the presence of the vessel during fog and other low visibility conditions on a body of water. The communication is displayed by the system in the form of a light display routine that can be a text communication, an image, an animation, a video, or a combination of them. The system includes a computer and a network to communicatively connect the computer to at least one splitter, at least control unit, and at least one light fixture, which can be an array of light emitting diodes. The computer commences the light display routine based on detection of a trigger event by analyzing data received from onboard sensor devices, an external source, or both.

### CROSS REFERENCE TO RELATED APPLICATIONS

This application is a nonprovisional application of and claims priority from U.S. provisional patent application Ser. No. 62/464,479 filed on Feb. 28, 2017. The foregoing application is incorporated in its entirety herein by reference.

### FIELD OF THE INVENTION

The invention relates to a communication system and methods for use aboard vessels. More particularly, the invention relates to an animated light media system installed aboard a vessel that alerts other vessels to the presence of the vessel during fog and other low visibility conditions in a body of water.

### BACKGROUND

Light fixtures installed aboard oceangoing or seagoing vessels are typically used for illumination purposes. Groupings of light fixtures having centrally coordinated control of their activation and deactivation have not been used on a large scale for safety purposes. Such dynamic lighting would be useful for onboard fog safety systems to alert nearby vessels of the presence of the vessel having the lighting during fog conditions as well as for aesthetic, entertainment, advertising, and informational purposes.

A need exists for a system that can produce large-scale light displays on a side of a vessel for use as a communication system to allow the vessel to warn other nearby vessels of its presence during fog and other low visibility conditions.

A need also exists for a system for displaying a communication from a vessel in a first location to a person in a second location that is sufficiently near to the first location that the communication is capable of being viewed by the person from the second location.

A need further exists for a system that can produce large-scale light displays on a side of a vessel to provide advertisements, information, and entertainment or to increase the aesthetic appeal of the vessel to persons not aboard the vessel but who are viewing the vessel from a distance.

### SUMMARY

The relates to a communication system that uses an animated light media system installed aboard a vessel to alert persons and other vessels of the presence of the vessel on which the system is installed during fog and other low visibility conditions in a body of water. The system includes a computer that includes software for controlling the system, a user interface that is accessible via a display connected to the computer, a network, a control unit for receiving commands from the computer via the network, at least one DMX control unit for converting signals received from the computer via the network and a splitter, and at least one light fixture capable of receiving converted signals from the DMX control unit via the network. The system can be activated during fog conditions or other significant weather events that reduce visibility such as during rain, thunderstorms, hurricane and tropical storms, smog, and smoke or at night to assist in alerting other nearby vessels to the presence of the vessel on which the system is installed thereby helping to avoid collisions. The system is used to display static images, static text, scrolling text, animations, or a combination of one or more of the foregoing on a side of the vessel by controlling the activation and deactivation of the light fixtures. The light fixtures may be installed on any side of the vessel, but generally, are installed on the port and starboard sides of the vessel.

In addition to its use as a safety system and safety and warning methods, the system and its methods can also be used to display advertisements or information on the side of a vessel or to increase the aesthetic appeal of one or more exterior facades of a vessel.

The system provides an advantage over flares, fog horns, and other traditional warning means and methods because it can produce bright and intense light displays on a large scale that drastically decrease the likelihood that such a warning signal would be missed in low visibility conditions by the crew of a nearby vessel. Another advantage of the system is its lower power consumption through use of LED lights in the light fixtures. Still another advantage of the system is its ability to use a single cable network to control and monitor both the light fixtures of the system as well as a separate public venue lighting system. Yet another advantage of the system is to produce images and animations that are clearly visible to persons not aboard the vessel who are located remotely at a distance from the vessel. Another advantage of the system is its ability to also be used to provide advertisements and information to persons not aboard the vessel and also to increase the general aesthetic appeal of the vessel to such persons, which may increase bookings aboard a cruise ship or other passenger vessel.

Accordingly, the invention features a system for alerting nearby vessels to the presence of a vessel to avoid collisions between the vessel and the nearby vessels. The system includes a computer having a processor, associated memory, and software for controlling the system. The system also includes a data source that transmits data to the computer, wherein the computer determines whether the data comprises a trigger event, and wherein the computer creates and transmits command signals when the trigger event is detected in the data. The system also includes a network for transmitting the command signals, and at least one splitter for receiving the command signals from the computer via the network and transmitting the command signals. The system further includes at least one control unit for receiving the command signals received from the computer via the at least one splitter and for creating control signals. The system also includes at least one light fixture capable of receiving the control signals from the at least one control unit. The at least one light fixture performs a light display routine based on the control signals received from the at least one control unit to which the at least one light fixture is connected.

In another aspect, the invention can feature the data source including a sensor device installed aboard the vessel or an external source remote from the vessel.

In another aspect, the invention can feature the light display routine including light fixture power-on to emit light, light fixture power-off to terminate light emission, light fixture color channel selection for emitting light of different colors from the at least one light fixture, and light brightening and dimming.

In another aspect, the invention can feature the computer including a graphical user interface accessible via a display connected to the computer. The at least one light fixture includes a plurality of light fixtures arranged in a matrix on an exterior surface of the vessel. The light display routine is stored in the associated memory and is capable of preview on the graphical user interface. The light display routine includes a display selected from among: text, an image, an animation, and a video.

In another aspect, the invention can feature the at least one light fixture including at least one light emitting diode.

In another aspect, the invention can feature the at least one light fixture being a RGBW LED light fixture.

In another aspect, the invention can feature the at least one light fixture being capable of changing brightness or intensity of light emitted therefrom.

In another aspect, the invention can feature the at least one light fixture being capable of changing color of light emitted therefrom.

In another aspect, the invention can feature the at least one light fixture including a plurality of light fixtures arranged in groups of two or more light fixtures, wherein each group of light fixtures is installed on a deck of the vessel and each light fixture within each group is communicatively connected to a control unit from which the light fixture receives commands; wherein the vessel comprises two or more decks.

In another aspect, the invention can feature the light fixtures of each group including two or more sub-groups of light fixtures; wherein each sub-group is communicatively connected to a different control unit of the at least one control unit; and wherein the control units connected to the sub-groups of light fixtures installed on the same deck are communicatively connected to a common splitter of the at least one splitter.

In another aspect, the invention can feature the vessel having two or more decks, wherein each deck includes one or more splitters of the at least one splitter installed thereon.

In another aspect, the invention can feature the light fixtures in each group being arranged in a generally linear configuration on the deck of the vessel.

In another aspect, the invention can feature the data source including one or more light sensors installed onboard the vessel, wherein the one or more light sensors detect a light level in a local environment of the vessel that is converted to light level data by the one or more light sensors. The light level data is transmitted from the one or more light sensors via the network to the computer. A system power application installed on the computer interprets the light level data to detect the existence or absence of the trigger event, which is a low light level relative to a threshold light level, and transmits a power-on command via the network to the control unit when the light level in the vessel's local environment equals or decreases below a light threshold value. The at least one light fixture is turned on to emit light in response to the power-on command.

In another aspect, the invention can feature the data source including one or more fog detection cameras installed onboard the vessel, wherein the one or more fog cameras transmit image data of a local environment of the vessel to the computer via the network. The image data includes images or video of a local environment of the vessel. A system power application installed on the computer interprets the image data to detect the existence or absence of the trigger event, which is a fog density determination relative to a fog density threshold, and when the fog density determination equals or exceeds a fog density threshold, the computer transmits a power-on command via the network to the control unit. The at least one light fixture is turned on to emit light in response to the power-on command.

In another aspect, the invention can feature the data source including one or more object detection devices installed onboard the vessel, wherein the object detection devices transmit to the computer via the network an object detection signal when an object is detected within a local environment of the vessel. A system power application installed on the computer interprets the object detection signal to detect the existence or absence of the trigger event, which is an object presence determination. The object presence determination includes distance of the object from the vessel, and when the object presence determination equals or decreases below a distance threshold, the computer transmits a power-on command via the network to the control unit. The at least one light fixture is turned on to emit light in response to the power-on command.

In another aspect, the invention can feature the object presence determination further including at least one of direction of movement of the object relative to the vessel and speed of forward movement of the object.

In another aspect, the invention can feature at least one of the control unit, the at least one splitter, and the at least one light fixture being weatherproof.

In another aspect, the invention can feature the at least one light fixture including a casing that is weatherproof, an array of light emitting diodes (LEDs), and a port for receiving a power cable that connects the array of LEDs to the at least one control unit. The casing includes a transparent or translucent cover so that light emitted by the LEDs passes through the cover.

In another aspect, the invention can feature the network being or being part of a lighting network of an existing public dimming system aboard the vessel.

In another aspect, the invention can feature the at least one light fixture including a plurality of light fixtures arranged in a matrix on an exterior surface of the vessel. The system further includes a user input device connected to the computer for inputting text that is transmitted for display by the matrix.

The invention also features a system for displaying a communication from a vessel in a first location to a person in a second location that is sufficiently near to the first location that the communication is capable of being viewed by the person from the second location. The system includes a computer having a processor, associated memory, and software for controlling the system. The system also includes a user input device connected to the computer and a light display selection module for selecting a communication. The communication is a light display routine selected from among two or more light display routines using the user input device. The system further includes a graphical user interface that is accessible via a display communicatively connected to the computer and displays a preview of the selected light display routine, a network for transmitting command signals, and at least one splitter for receiving the command signals from the computer via the network and transmitting the command signals. The system also includes at least one control unit for receiving the command signals from the computer via the at least one splitter and for creating and transmitting control signals. The system also includes a plurality of light fixtures arranged in a matrix on an exterior surface of the vessel and capable of receiving the control signals from the at least one control unit. The plurality of light fixtures performs the selected light display routine based on the control signals received from the at least one control unit to which the at least one light fixture is connected.

In another aspect, the invention can feature the communication being a text communication, an image, an animation, a video, or a combination of two or more of the foregoing.

A computer-implemented method can be used for alerting nearby vessels to the presence of a vessel to avoid collisions between the vessel and the nearby vessels. The method includes the steps of: (a) selecting a light matrix display routine using a user input device connected to a computer, wherein the computer includes a processor and associated memory for storing the light matrix display routine; (b) transmitting a command signal encoding the selected light matrix display routine via a network to at least one splitter, which further transmits the command signal to at least one control unit; and (c) transmitting a control signal from the at least one control unit to at least one light fixture installed so that light emitted by the at least one light fixture is visible from outside the vessel, wherein the at least one light fixture displays the selected light matrix display routine to visually alert at least one nearby vessel of the vessel's presence.

Another method of the invention can include step (b) of the method being performed after the following steps: (d) receiving data from an external source remote from the vessel; and (e) using software installed on the computer, determining existence or absence of a trigger event; wherein if the trigger event is determined to exist, the computer creates the command signal; and wherein if the trigger event is determined to be absent, the computer does not create the command signal.

Another method of the invention can include step (b) of the method being performed after the following steps: (f) receiving data from a sensor device aboard the vessel; and (g) using software installed on the computer, determining existence or absence of a trigger event; wherein if the trigger event is determined to exist, the computer creates the command signal; and wherein if the trigger event is determined to be absent, the computer does not create the command signal.

The invention also features a computer program embodied on a computer readable non-transitory medium including computer executable program code, which when executed by at least one processor of a device, causes the device to: (a) select a light matrix display routine using a user input device connected to a computer, wherein the computer includes a processor and associated memory for storing the light matrix display routine; (b) transmit a command signal encoding the selected light matrix display routine via a network to at least one splitter, which further transmits the command signal to at least one control unit; and (c) transmit a control signal from the at least one control unit to at least one light fixture installed so that light emitted by the at least one light fixture is visible from outside the vessel, wherein the at least one light fixture displays the selected light matrix display routine to visually alert at least one nearby vessel of the vessel's presence.

Unless otherwise defined, all technical terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents and other references mentioned herein are incorporated by reference in their entirety. In the case of conflict, the present specification, including definitions will control.

### BRIEF DESCRIPTION OF THE DRAWINGS

FIG. 1A is a diagram of one possible embodiment of a fog safety system.

FIG. 1B is a continuation of the diagram of FIG. 1A.

FIG. 2 is a front perspective view of one embodiment of a light fixture that can be used with the system of FIGS. 1A and 1B without LED lights installed therein.

FIG. 3 is a perspective view of one possible configuration in which light fixtures of the system of FIGS. 1A and 1B can be mounted to an exterior façade of a vessel.

FIG. 4A is a diagram of another possible embodiment of a fog safety system.

FIG. 4B is a continuation of the diagram of FIG. 4A.

FIG. 5 is another diagram of a system for displaying a communication from a vessel in a first location to a person in a second location that is sufficiently near to the first location that the communication is capable of being viewed by the person from the second location, wherein software and components of the computer are shown.

### DETAILED DESCRIPTION

The present invention is best understood by reference to the detailed drawings and description set forth herein. Embodiments of the invention are discussed below with reference to the drawings; however, those skilled in the art will readily appreciate that the detailed description given herein with respect to these figures is for explanatory purposes as the invention extends beyond these limited embodiments. For example, in light of the teachings of the present invention, those skilled in the art will recognize a multiplicity of alternate and suitable approaches, depending upon the needs of the particular application, to implement the functionality of any given detail described herein beyond the particular implementation choices in the following embodiments described and shown. That is, numerous modifications and variations of the invention may exist that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

The present invention should not be limited to the particular methodology, compounds, materials, manufacturing techniques, uses, and applications, described herein, as these may vary. The terminology used herein is used for the purpose of describing particular embodiments only, and is not intended to limit the scope of the present invention. As used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” may be a reference to one or more steps or means and may include sub-steps and subservient means.

All conjunctions used herein are to be understood in the most inclusive sense possible. Thus, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should be read as “and/or” unless expressly stated otherwise. Structures described herein are to be understood also to refer to functional equivalents of such structures. Language that may be construed to express approximation should be so understood unless the context clearly dictates otherwise.

Unless otherwise defined, all terms (including technical and scientific terms) are to be given their ordinary and customary meaning to a person of ordinary skill in the art, and are not to be limited to a special or customized meaning unless expressly so defined herein.

Terms and phrases used in this application, and variations thereof, especially in the appended claims, unless otherwise expressly stated, should be construed as open ended as opposed to limiting. As examples of the foregoing, the term “including” should be read to mean “including, without limitation,” “including but not limited to,” or the like; the term “having” should be interpreted as “having at least”; the term “includes” should be interpreted as “includes but is not limited to”; the term “example” is used to provide exemplary instances of the item in discussion, not an exhaustive or limiting list thereof; and use of terms like “preferably,” “preferred,” “desired,” “desirable,” or “exemplary” and words of similar meaning should not be understood as implying that certain features are critical, essential, or even important to the structure or function of the invention, but instead as merely intended to highlight alternative or additional features that may or may not be utilized in a particular embodiment of the invention.

Those skilled in the art will also understand that if a specific number of an introduced claim recitation is intended, such an intent will be explicitly recited in the claim, and in the absence of such recitation no such intent is present. For example, as an aid to understanding, the appended claims may contain usage of the introductory phrases “at least one” and “one or more” to introduce claim recitations; however, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C” is used, in general, such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.).

All numbers expressing dimensions, quantities of ingredients, reaction conditions, and so forth used in the specification are to be understood as being modified in all instances by the term “about” unless expressly stated otherwise. Accordingly, unless indicated to the contrary, the numerical parameters set forth herein are approximations that may vary depending upon the desired properties sought to be obtained.

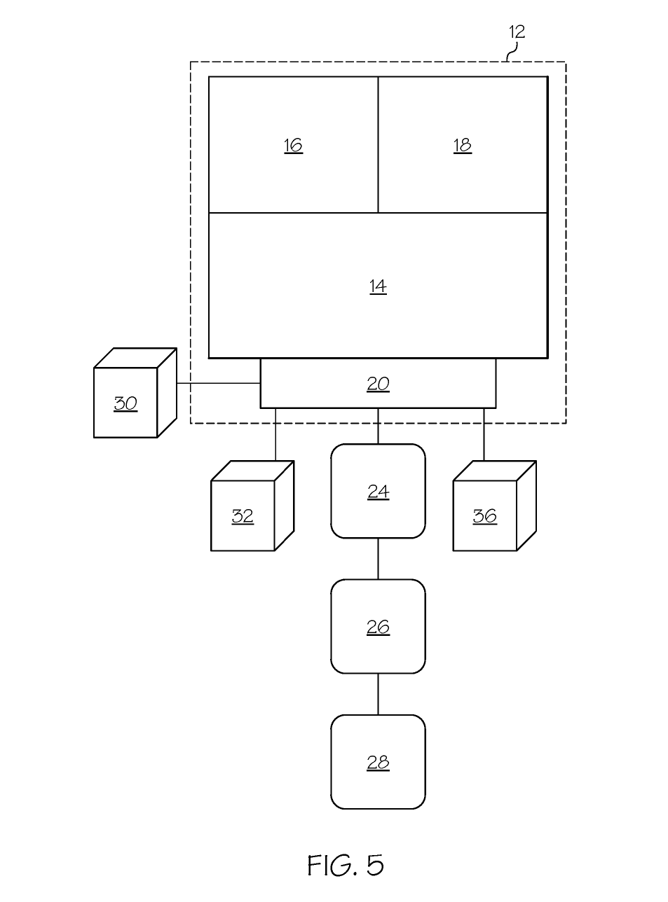

The invention provides a system for creating a light display image on an exterior façade of a cruise ship or other vessel to provide visual notice of the presence of the vessel to other nearby vessels during fog and other low visibility conditions. The invention also provides a system for displaying a communication from a vessel in a first location to a person in a second location that is sufficiently near to the first location that the communication is capable of being viewed by the person from the second location. The light display image can be a static image such as text, a symbol, or other image, or an animated visual light display that presents a moving image or animation such as a video. The system can also be used as a dynamic lighting system to display animated and static visual media on the façade of a vessel for aesthetic, advertising, or other purposes. The system 10 includes a computer 12, which includes a processor 14, associated memory 16, and software 18 for controlling the system. The system 10 further includes a network interface 20 that communicatively connects the computer 12 to the network 22. The computer 12 is communicatively connected to at least one splitter 24 via the network 22. The at least one splitter 24 is communicatively connected to at least one control unit 26. The at least one control unit 26 is communicatively connected to at least one light fixture 28. One example of the foregoing embodiment of the system is shown in FIG. 5. All of these components of the system are installed on a vessel 100. One or more components of the system may be waterproof, weatherproof, or water or weather-resistant. The components of the system can be constructed from materials that are resistant to corrosion and degradation by heat and sunlight.

The vessel 100 can be any type of vessel, whether oceangoing or for inland navigable waters. The system is most useful on a vessel 100 having multiple decks (or levels or floors) but at least two decks although versions of the system can be used on vessels having only a single deck. In exemplary embodiments, the vessel 100 is a passenger ship. More particular, in the most exemplary embodiments, the vessel 100 is a cruise ship. In exemplary embodiments, the at least one light fixture includes a plurality of light fixtures that are installed on an exterior surface of the port and starboard sides of the vessel, although in some embodiments, light fixtures may also be installed on the bow or stern of the vessel. In various embodiments, light fixtures may be installed only on the port and starboard sides, only on the bow and stern, or in any other combination of sides of the vessel.

In exemplary embodiments of the system 10, the computer 12 is connected to the at least one splitter 24, the at least one control unit 26, and the at least one fixture via wired connections that form the network. In other embodiments, the computer 12 is connected to those components of the system 10 by a wireless network with at least some of the at least one splitter 24, the at least one control unit 26, and the at least one fixture including devices for transmitting and receiving data or command or control signals via the wireless network (e.g. a wireless local area network (WLAN) based on Wi-Fi). The computer transmits command signals to the splitters, which then transmit those command signals to the control units, which in turn, convert the command signals to control signals that area transmitted by the control units to the light fixtures. The computer can also receive data in the form of signals transmitted from data sources to the computer and from the light sources and control units to the computer.

The system 10 includes one or more user input devices that can be manipulated by a user to control the system. Examples of user input devices the system may include are: a keyboard, a mouse or other pointing device, a trackball input device, a touchscreen display, a stylus, a button, a knob, a lever, a slide control, a joystick, a portable remote control, and any other suitable user input device for making selections and controlling features of the system.

In one embodiment, the system can feature the data source including one or more light sensors installed onboard the vessel, which are capable of detecting a light level in a local environment of the vessel. The detected light level is converted to light level data by the one or more light sensors. The light level data is transmitted from the one or more light sensors via the network to the computer. A system power application installed on the computer interprets the light level data to detect the existence or absence of a trigger event, which in this embodiment, can be a low light level relative to a threshold light level. The computer then transmits a power-on command via the network to the control unit when the light level in the vessel's local environment equals or decreases below a light threshold value. The at least one light fixture is turned on to emit light in response to the power-on command.

In another embodiment, the system can feature the data source including one or more fog detection cameras installed onboard the vessel, which can transmit image data of a local environment of the vessel to the computer via the network. The image data includes images or video of a local environment of the vessel. A system power application installed on the computer interprets the image data to detect the existence or absence of the trigger event, which in this embodiment, is a fog density determination relative to a fog density threshold. When the fog density determination equals or exceeds a fog density threshold, the computer transmits a power-on command via the network to the control unit. The control unit then transmits a control signal to the at least one light fixture, which then is turned on to emit light in response to the power-on command sent by the computer to the control unit.

In another embodiment, the system can feature the data source including one or more object detection devices installed onboard the vessel, which transmit to the computer via the network an object detection signal when an object is detected within a local environment of the vessel. A system power application installed on the computer interprets the object detection signal to detect the existence or absence of the trigger event, which is an object presence determination. The object presence determination includes distance of the object from the vessel, and when the object presence determination equals or decreases below a distance threshold, the computer transmits a power-on command via the network to the control unit. The control unit then transmits a control signal to the at least one light fixture, which then is turned on to emit light in response to the power-on command. The object presence determination can also include a direction of movement of the object relative to the vessel and/or a speed of forward movement of the object. The object can be another vessel, for example.

In some embodiments, the system 10 can also include a global positioning system (GPS) device 30 that can be communicatively connected to the computer 12 via the network interface 20. The GPS device 30 determines an accurate geographic location of the vessel 100 based on data received from a global positioning satellite system. The computer 12 can create and transmit command signals to the at least one control unit 26 to control operation of the at least one light fixture 28 based on location information obtained from the GPS device 30.

In some embodiments, the system 10 can also include a display 32 communicatively connected to the computer for displaying a graphical user interface 34. In some embodiments, the display 32 can be a touchscreen display so that the display serves as a user input device. For example, in such embodiments, the user may manually control the system by touching or otherwise manipulating with a finger, hand, stylus, or other object certain icons and other control features digitally displayed on the graphical user interface.

In exemplary embodiments, the computer 12 can receive data from a data source that is either installed onboard the vessel or is located in a remote location. The computer interprets the data to determine whether the data includes a trigger event that requires execution of a command by the system (e.g., commencement of a light display routine). When the computer detects a trigger event within the data, the computer creates and transmits command signals to the at least one control unit 26 of the system via the network. For example, in some embodiments, the data source of the system 10 can be at least one sensor device 36 installed onboard the vessel 100. Examples of sensor devices 36 that may be installed aboard the vessel include light sensors, photoelectric sensors, motion detectors (e.g., an acoustic sensor, an infrared sensor, a microwave sensor, or an optical sensor), pressure sensors, humidity sensors, cameras, video cameras, and any other suitable sensor device capable of capturing and transmitting data related to conditions of the vessel's surrounding environment that are useful for determining when to activate and deactivate the system.

The light display routine performed by the at least one light fixture includes, for example, light fixture power-on to emit light, light fixture power-off to terminate light emission, light fixture color channel selection for emitting light of different colors from the at least one light fixture, and light brightening and dimming to bright or dim the light emitted by the light fixture. In exemplary embodiments in which each light fixture includes multiple LED lights of different colors, the computer may send command signals for a light display routine in which some of the LED lights are turned on to emit light while others in the light fixture are turned off, or some of the LED lights may be increased in brightness of the light they emit while others are dimmed but continue to emit light.

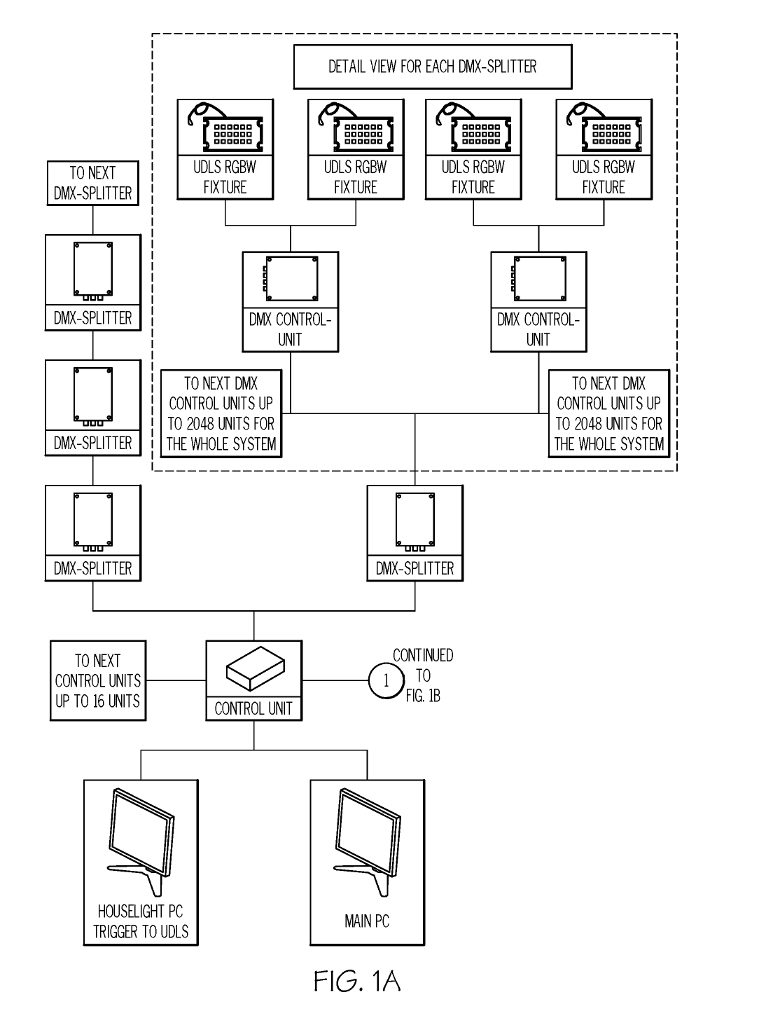

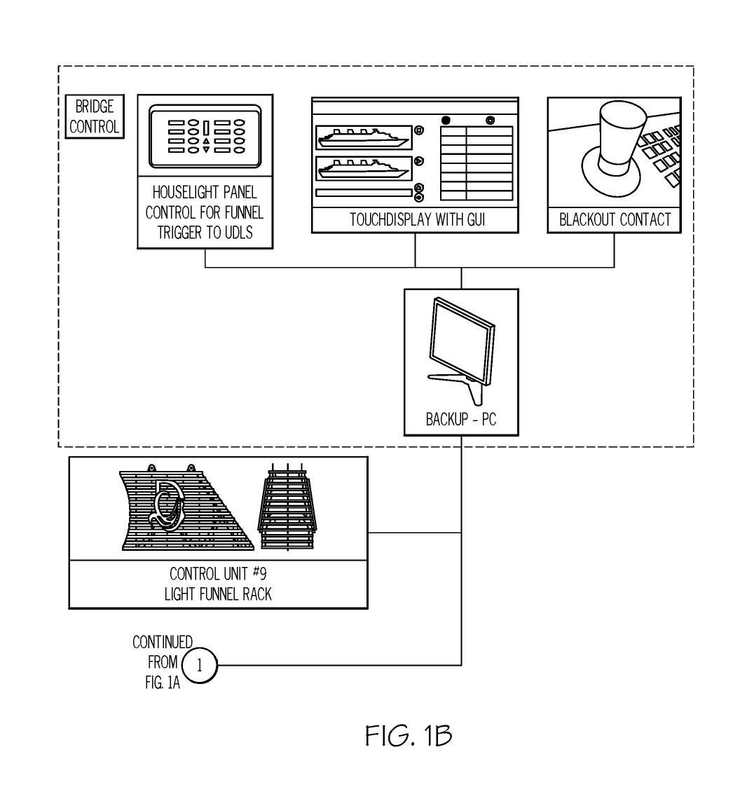

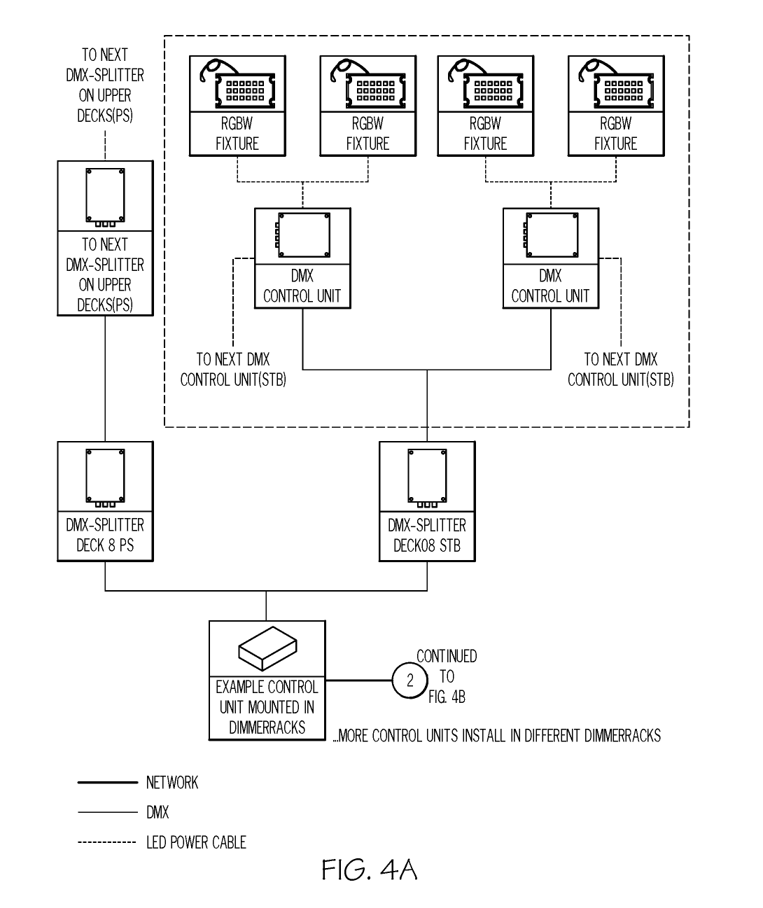

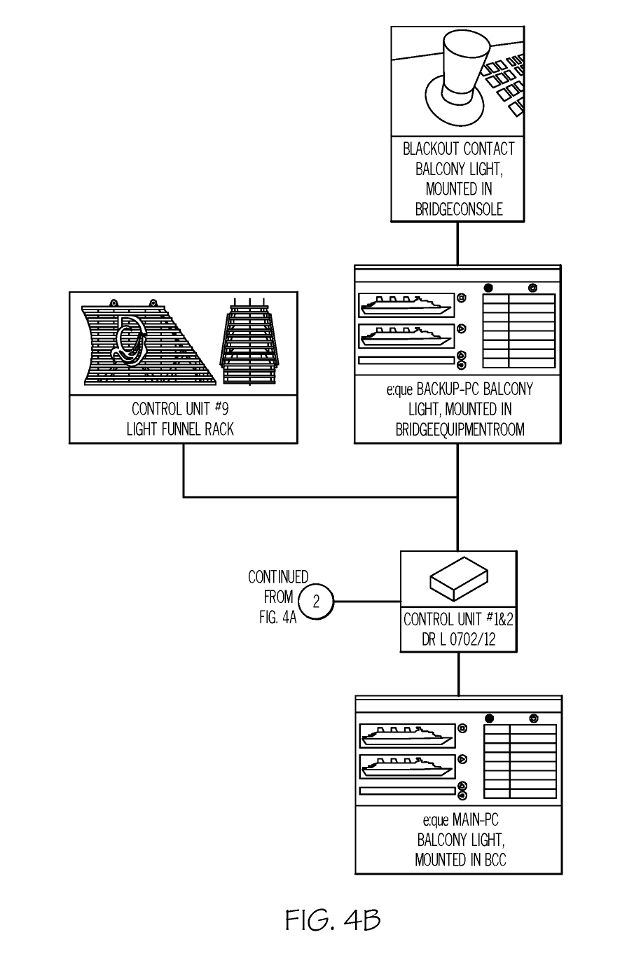

As shown in FIGS. 1A and 1B and in FIGS. 4A and 4B, the system 10 includes a computer 12 that includes software 14 for controlling the system, a user interface that is accessible via a display connected to the computer, a network, a control unit for receiving commands from the computer, a splitter, at least one DMX control unit for converting signals received from the computer via the network and splitter, and at least one light fixture capable of receiving converted signals from the DMX control unit. In exemplary embodiments, the at least one control unit is one or more DMX control units that are communicatively connected by DMX cables to one another and to at least one DMX splitter. Each DMX control unit is communicatively connected to at least one LED light fixture by a LED power cable.

The user interface can be a graphical user interface (GUI) that is displayed on a display screen or monitor connected directly to the computer. In other embodiments, the GUI may be accessible via a device having a display screen, wherein the device is indirectly connected to the computer, which can be remotely located. For example, the display screen device can be connected to the computer via a wireless network. In exemplary embodiments, the GUI displays control features that may be activated, deactivated, or otherwise controlled via interaction by a user with the system via graphical icons and other visual indicators displayed as part of the GUI. In other embodiments, the user interface could also use text-based controls including, for example, controls that require typing commands. The GUI can include features to allow the system to be activated and deactivated, various light color schemes to be selected for the vessel, or various static images or animations to be displayed. Static images and animations can be stored in the system and displayed as preset options for activation by a user. The user may view these options on the GUI before selecting one for display on the vessel. In another embodiment, the system can include the ability to download to the computer new static images and animations from the Internet, another network, or a media storage device such as, for example, a computer or flash drive. The GUI may also include a feature that permits text to be typed into the system so that the computer is programmed to display such typed text in the form of a static image or scrolling text using the light fixtures of the system.

The computer can be any computing device capable of connecting to a display for displaying the GUI and for hosting the software that operates the system. For example, the computing device can be a desktop computer, a laptop computer, a tablet computer, or a mobile phone. In exemplary embodiments of the system, the computer can be a computing device that is integrated with or is the same as another computer or computers in a bridge of a vessel.

The network is formed by the connection of communicative cables with the computer, light fixtures, and other components of the system. Because the system is installed aboard ships, two different types of cable may be used. One type of cable is used indoors within the ship, and a second weather-resistant cable is installed for outdoor usage. The network transmits commands from the computer to the lighting fixtures. The network can also transmit signals from the light fixtures to the computer and from other components of the system to the computer and to the light fixtures.

In one embodiment, the network can transmit signals from the light fixtures to the computer. The light fixtures may include a sensor device configured to provide feedback or control input to the computer for controlling the system. The sensor device may provide, for example, ambient light sensor information about the environment for adjusting brightness or color of the light fixtures, for example. The sensor device may also provide detection information of a nearby object (e.g., another vessel) and transmitting the detected remote object information to the computer for controlling the system control software.

In one embodiment, the network can transmit signals from other components of the system to the computer. Marine vessel internal data system signals can be used as input for the computer implemented control method at the computer. For example, Automatic Identification System (AIS) data, radar data, weather forecast information, or other available information can be used as input for the computer implemented control method at the computer. Furthermore, any vessel sensor provided data may be used as well.

In one embodiment, the cable network can be a dual purpose cable network in that it allows the computer (i) to control the light fixtures, and (ii) to control the power and dimming feature of a separate public venue lighting system to which the cable network can also be connected. By using the cable network for both purposes rather than running two separate networks of cable through the vessel, costs, usage of materials, and maintenance are reduced while efficiency both in operation and in installation and space usage are improved.

In an alternate embodiment, the light fixtures and other components of the system can be connected to electrical cables as a power source but can receive commands from the computer via connections to a wireless network aboard the vessel.

As previously mentioned, the computer is connected by the network to the control unit. The control unit converts command signals received from the computer into Digital Multiplex (DMX) signals that can be transmitted to the splitter. The splitter transmits the signals it receives from the control unit to the DMX control unit via the network.

In exemplary embodiments, the system includes a plurality of light fixtures connected and a plurality of DMX control units. One or more light fixtures are connected to each DMX control unit. In one exemplary embodiment, two light fixtures are connected to each DMX control unit, which in turn, is connected to a splitter.

The DMX control units receive the DMX signals transmitted from the control unit and spread by the splitter and then converts those DMX signals to pulse-width modulation (PWM) signals capable of being received as commands by the light fixtures.

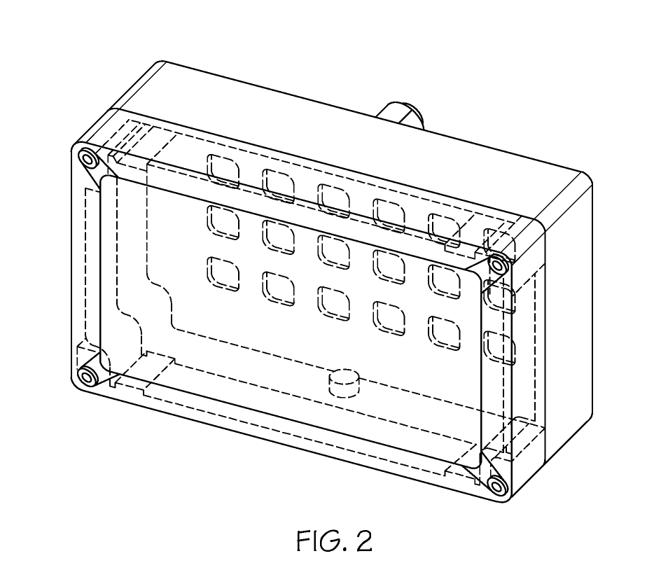

As shown in FIG. 2, each light fixture can include a casing. The casing can include a removable cover so that light sources (e.g., light bulbs, LEDs, or other light-producing devices) installed therein can be accessed and replaced. The casing can include connection points or apertures for connecting the network to each light source. Each light fixture includes one or a plurality of light sources. In embodiments of the system that include a plurality of light sources per light fixture, each light fixture may include 2, 3, 4, 5, 6, 7, 8, 9, 10, 11, 12, or more light sources. The number of light sources in each light fixture may be uniform or may vary. The color of light produced by each light source may be uniform or may vary. The color of light produced by each light fixture may also be uniform or may vary depending on the color of the light sources installed therein. In an exemplary embodiment, the light sources are light-emitting diode (LED) lights, which can be RBG LEDs or RBGW LEDs. In one exemplary embodiment, each light fixture can include 6×3 RBGW LEDs, meaning a panel of RBGW LEDs arranged in three columns of six RBGW LEDs each (or 18 total). In exemplary embodiments, the light sources selected for use in the light fixtures should feature high light output or intensity as well as comparatively low power consumption, which renders LED lights ideal for use with the system. The light fixtures are installed on port and starboard sides of the vessel, although in some embodiments, light fixtures can also be installed on either or both of the bow and stern of the vessel. The system can display the same light display image on each side of the vessel or different light display images on each side.

The casing can be weatherproof so that it protects the array of light emitting diodes (LEDs) enclosed therein. The casing includes a port for receiving a power cable that connects the array of LEDs to the at least one control unit. The casing can include a transparent or translucent cover so that light emitted by the LEDs passes through the cover while still protecting the array of LEDs within in from exposure to damage from weather and physical contact.

The light fixtures (or their constituent LED lights) can include remote device management (RDM) features that permit bidirectional communication between the light fixtures and the computer. The RDM feature allows the computer to collect data on the functionality of each light fixture so that malfunctioning light fixtures can be detected and repaired or replaced.

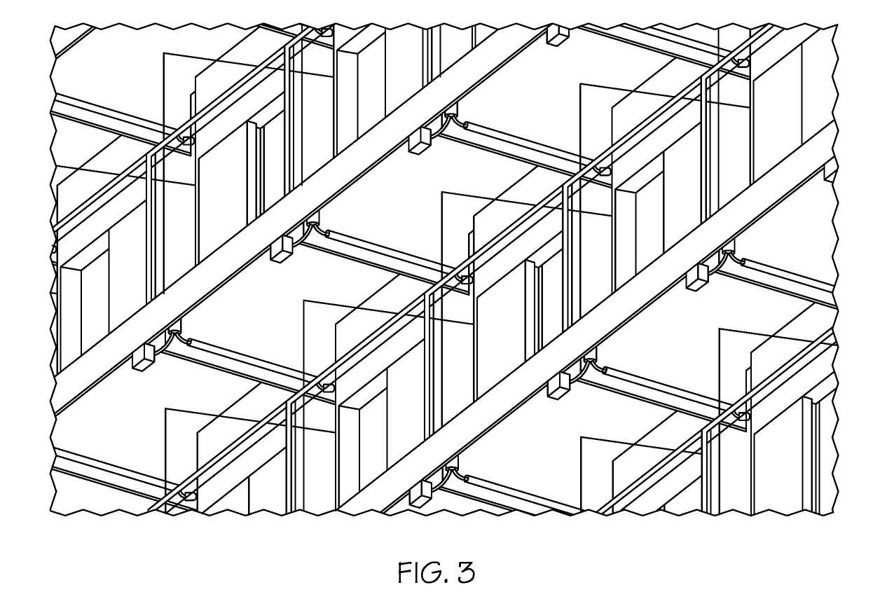

As shown in FIG. 3, the light fixtures can be installed above or below a balcony or window of each cabin of the vessel wherein the vessel is a cruise ship. When activated, the matrix of light fixtures produces the light display image. For example, on a cruise ship having six floors of 105 exterior cabins each on one side of the vessel, a matrix resolution of light display images produced by the system on that side of the vessel is 105×6 pixels. In other vessels, the light fixtures may be installed at selected intervals across the side of the ship. In exemplary embodiments, the at least one light fixture includes a plurality of light fixtures arranged in a matrix on an exterior surface of the vessel. For example, in the various embodiments of the system described herein, the exterior surface of the vessel to which the light fixtures are attached can be a balcony, a handrail, a railing, a side shell, a window, or any other exterior surface of the vessel. The light display routine is stored in the associated memory of the computer and is capable of being previewed on the graphical user interface. The light display routine includes a display selected from among the following: text, an image, an animation, a video, and a combination of two or more of the foregoing. When viewed from a distance, the controlled, sequential powering on, powering off, brightening, dimming, and color changes of the LED lights in the plurality of light fixtures create an animation or video that appears to move.

In one embodiment, at least one light fixture can be installed above or below a balcony or window of each cabin of the vessel, wherein the vessel is a cruise ship. The light fixture can be integrated to a cabin light system of the vessel. In a first (fog light) mode, the light fixture or at least one light source of the light fixture can be used as “fog lights” and directed outward or away from the vessel, e.g., towards another vessel, and in a second (emergency) mode, such as in an emergency state, light of the light fixture is directed to the cabin for alerting passengers due to the emergency. In the second mode, the light emitted by the light fixture may also be directed outward or away from the vessel to indicate emergency status to other vessels or rescue teams. In a third (normal), the light fixture may be used for normal lighting of the cabin or some other public part of the vessel. The direction of light emitted by the light fixture or the light source may be configured to be changed by using a movable platform for the light fixture and/or the light source, or some screening/reflecting element may be used to dynamically adjust direction of the light beams.

Although any number of light fixtures may be used, in an exemplary embodiment, 600 light fixtures can be installed on each side of the vessel. In other embodiments, the number of light fixtures installed on a vessel may range from 1 to 10,000 or more. Equal number of light fixtures may be installed on each side of a vessel, or the number of light fixtures installed on each side of the vessel may differ. When viewed up close or from aboard the vessel, the light display image produced by the light fixtures generally is not visible. However, when viewed from a distance remote from the vessel (e.g., at 400, 500, 600, 700, 800, 900, 1,000 meters or more), a person viewing the vessel will have a viewing experience that is homogeneous, meaning that instead of seeing only individual light fixtures, the viewer will not be able to distinguish between light fixtures at such distances so that the light fixtures product a single image similar to a video display screen like a computer monitor or television, wherein each light fixture represents a pixel.

The computer can be programmed to activate and deactivate the LED lights of the light fixtures in programmed sequences so that they display an image or animation that is visible even from a far distance due to the large scale of the light fixtures' installation on the side or sides of the vessel. The animation could be similar to video in quality depending on the number of light fixtures installed on the exterior façade of the vessel. Examples of animations that could be displayed using the system are scrolling text, a video, or other animated images. Other examples of animations that could be displayed using the system are light show displays, image of individuals dancing, and any other suitable animation (including video) that can be displayed using the system. The light fixtures can display a mixture of static images, static text, scrolling text, and/or animations.

In one embodiment, the computer can be programmed to activate and deactivate the LED lights of the light fixtures in programmed sequences in response to received triggering inputs. The triggering inputs may comprise, for example, weather information, time information or environmental information. Weather information may trigger the lights when the computer is configured to determine that fog is present around the vessel. Time information may trigger the lights when the computer is configured to determine that there is darkness outside the vessel. Environmental information may trigger the lights when the computer is configured to determine that measured sensor indicate fog, heavy rain or another low visibility factor around the vessel. Environmental information may also trigger the lights when the computer is configured to determine (e.g., based on GPS or other positioning device) that the vessel is approaching some dangerous, tricky, or special location via its route, such as a narrow strait or a harbor/dock, for example. Further inputs may be used for triggering, such as time-based, weather-based, ambient light sensor-based, detection of remote objects, location-based, etc.

In fog conditions on the ocean, sea, lake, river, or other body of water, the system can be activated to display a warning to other vessels in close proximity to the vessel on which the system is installed to assist in avoiding collisions. For example, the system can be programmed to produce bursts of light from the light fixtures, a warning symbol or color of light (e.g., red), or scrolling text that provides information. The scrolling text could read “CRUISE SHIP PRESENT,” “VESSEL PRESENT,” “WARNING,” “BEWARE,” or the like or the scrolling text could provide the name, maritime call sign, location coordinates, ship size, ship type (e.g., cruise ship or cargo ship), and/or heading of the vessel. In an emergency situation, the text or scrolling text could read “SOS,” “S.O.S.,” or some other distress signal.

In one embodiment, content for the information to be provided by the system may be selected from at least one of a plurality of content sources. The plurality of content sources may comprise at least one of the following: vessel data system, AIS system, external content data system with an access to the controlling computer, and the controlling computer with a user interface, for example.

In one embodiment, a detecting device may utilize a camera or similar device to automatically detect another vessel's “fog safety” information and to generate responsive information on the vessel's own light system (i.e. “fog safety system”).

The system may be activated during fog conditions, and particularly during heavy fog and other low visibility events, as a warning system to alert or warn other nearby vessels of the presence of the vessel on which the system is installed so that collisions between vessels can be avoided. The system can also be used to draw attention to a disabled vessel or a vessel experiencing another emergency that requires assistance from other nearby vessels. In one embodiment, the light fixtures could display a static text message or scrolling text that reads “MAN OVERBOARD” to alert nearby vessels that a passenger or crew member has fallen into the surrounding water and requires rescue.

In one embodiment, man over board (MOB) (i.e., a person who has fallen off the vessel) may be detected with a movement sensor that may be integrated to the at least one light fixture so that if a human is falling vertically through air above water, a MOB alarm is triggered. Based on the triggered MOB alarm, lights of the at least one light fixture may be configured to be controlled by the control system. The lights may be directed to a detected position based on the MOB alarm. The light system with at least one light fixture performs a light display routine based on the MOB alarm and may provide for example accurate location information where the MOB was triggered, as content displayed by the light fixtures as a static message or scrolling text that reads or indicates the location information controlled by the computing device. For example, the content that includes location information related to the MOB event can be displayed on an external surface of the vessel using the light fixtures. Thus, a rescue crew receives accurate MOB location information easily and quickly when approaching the MOB location, for example. Additionally, the MOB location information can be provided to a display connected to the computer, on other computing devices having displays and wired or wireless connections to the network, or on handheld computing devices (e.g., tablet computers, personal digital assistants, and smart phones) that include a wired or wireless connection to the system.

Examples of low visibility conditions in or on a body of water, as used herein, include fog, rain, hail, snow, smoke, smog, and nighttime or darkness.

The invention also features a computer program embodied on a computer readable non-transitory medium including computer executable program code, which when executed by at least one processor of a device, causes the device to select a light matrix display routine using a user input device connected to a computer. The computer includes a processor and associated memory for storing the light matrix display routine. When executed by the at least one processor of the device, the computer executable program code next causes the device to transmit a command signal encoding the selected light matrix display routine via a network to at least one splitter, which further transmits the command signal to at least one control unit. The device then transmits a control signal from the at least one control unit to at least one light fixture installed so that light emitted by the at least one light fixture is visible from outside the vessel. The at least one light fixture displays the selected light matrix display routine to visually alert at least one nearby vessel of the vessel's presence.

The invention also relates to a computer-implemented method that can be used for alerting nearby vessels to the presence of a vessel to avoid collisions between the vessel and the nearby vessels. The method includes the step of selecting a light matrix display routine using a user input device connected to a computer. The computer includes a processor and associated memory for storing the light matrix display routine. The method also includes the step of transmitting a command signal encoding the selected light matrix display routine via a network to at least one splitter, which further transmits the command signal to at least one control unit. The method further includes the step of transmitting a control signal from the at least one control unit to at least one light fixture installed so that light emitted by the at least one light fixture is visible from outside the vessel. The at least one light fixture then displays the selected light matrix display routine to visually alert at least one nearby vessel of the vessel's presence.

In some embodiments of the method, the step of transmitting a command signal can be performed after the intervening steps of receiving data from an external source remote from the vessel, and then, using software installed on the computer, determining existence or absence of a trigger event. If the trigger event is determined to exist, the computer creates the command signal, and if the trigger event is determined to be absent, the computer does not create the command signal.

In some embodiments of the method, the step of transmitting a command signal can be performed after the intervening steps of receiving data from a sensor device aboard the vessel, and then, using software installed on the computer, determining existence or absence of a trigger event. If the trigger event is determined to exist, the computer creates the command signal, and if the trigger event is determined to be absent, the computer does not create the command signal.

### Other Embodiments

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A system for alerting nearby vessels to the presence of a vessel to avoid collisions between the vessel and the nearby vessels, the system comprising:
a computer comprising a processor, associated memory, and software for controlling the system;
a data source that transmits data to the computer, wherein the computer determines whether the data comprises a trigger event, and wherein the computer creates and transmits command signals when the trigger event is detected in the data;
a network for transmitting the command signals;
at least one splitter for receiving the command signals from the computer via the network and transmitting the command signals;
at least one control unit for receiving the command signals received from the computer via the at least one splitter and for creating control signals; and
at least one light fixture capable of receiving the control signals from the at least one control unit; wherein the at least one light fixture performs a light display routine based on the control signals received from the at least one control unit to which the at least one light fixture is connected.

2. The system of claim 1, wherein the data source comprises a sensor device installed aboard the vessel or an external source remote from the vessel.

3. The system of claim 1, wherein the light display routine comprises light fixture power-on to emit light, light fixture power-off to terminate light emission, light fixture color channel selection for emitting light of different colors from the at least one light fixture, and light brightening and dimming.

4. The system of claim 1, wherein the computer comprises a graphical user interface accessible via a display connected to the computer; wherein the at least one light fixture comprises a plurality of light fixtures arranged in a matrix on an exterior surface of the vessel; wherein the light display routine is stored in the associated memory and capable of preview on the graphical user interface; and wherein the light display routine comprises a display selected from the group consisting of: text, an image, an animation, a video, and a combination of two or more of the foregoing.

5. The system of claim 1, wherein the at least one light fixture comprises at least one light emitting diode.

6. The system of claim 2, wherein the at least one light fixture comprises a RGBW LED light fixture.

7. The system of claim 1, wherein the at least one light fixture is capable of changing brightness or intensity of light emitted therefrom.

8. The system of claim 1, wherein the at least one light fixture is capable of changing color of light emitted therefrom.

9. The system of claim 1, wherein the at least one light fixture comprises a plurality of light fixtures arranged in groups of two or more light fixtures, wherein each group of light fixtures is installed on a deck of the vessel and each light fixture within each group is communicatively connected to a control unit from which the light fixture receives commands; wherein the vessel comprises two or more decks.

10. The system of claim 9, wherein the light fixtures of each group comprise two or more sub-groups of light fixtures; wherein each sub-group is communicatively connected to a different control unit of the at least one control unit; and wherein the control units connected to the sub-groups of light fixtures installed on the same deck are communicatively connected to a common splitter of the at least one splitter.

11. The system of claim 1, wherein the vessel comprises two or more decks, wherein each deck comprises one or more splitters of the at least one splitter installed thereon.

12. The system of claim 9, wherein the light fixtures in each group are arranged in a generally linear configuration on the deck of the vessel.

13. The system of claim 1, wherein the data source comprises one or more light sensors installed onboard the vessel, wherein the one or more light sensors detect a light level in a local environment of the vessel that is converted to light level data by the one or more light sensors; wherein the light level data is transmitted from the one or more light sensors via the network to the computer; wherein a system power application installed on the computer interprets the light level data to detect the existence or absence of the trigger event comprising a low light level and transmits a power-on command via the network to the control unit when the light level in the vessel's local environment equals or decreases below a light threshold value; and wherein the at least one light fixture is turned on to emit light in response to the power-on command.

14. The system of claim 1, wherein the data source comprises one or more fog detection cameras installed onboard the vessel, wherein the one or more fog cameras transmit image data of a local environment of the vessel to the computer via the network; wherein the image data comprises images or video of a local environment of the vessel; wherein a system power application installed on the computer interprets the image data to detect the existence or absence of the trigger event comprising a fog density determination, and when the fog density determination equals or exceeds a fog density threshold, the computer transmits a power-on command via the network to the control unit; and wherein the at least one light fixture is turned on to emit light in response to the power-on command.

15. The system of claim 1, wherein the data source comprises one or more object detection devices installed onboard the vessel, wherein the object detection devices transmit to the computer via the network an object detection signal when an object is detected within a local environment of the vessel; wherein a system power application installed on the computer interprets the object detection signal to detect the existence or absence of the trigger event comprising an object presence determination, wherein the object presence determination comprises distance of the object from the vessel, and when the object presence determination equals or decreases below a distance threshold, the computer transmits a power-on command via the network to the control unit; and wherein the at least one light fixture is turned on to emit light in response to the power-on command.

16. The system of claim 15, wherein the object presence determination further comprises at least one of direction of movement of the object relative to the vessel and speed of forward movement of the object.

17. The system of claim 1, wherein at least one of the control unit, the at least one splitter, and the at least one light fixture is weatherproof.

18. The system of claim 17, wherein the at least one light fixture comprises a casing that is weatherproof, an array of light emitting diodes (LEDs), and a port for receiving a power cable that connects the array of LEDs to the at least one control unit, wherein the casing comprises a transparent or translucent cover so that light emitted by the LEDs passes through the cover.

19. The system of claim 1, wherein the network comprises a lighting network of an existing public dimming system aboard the vessel.

20. The system of claim 1, wherein the at least one light fixture comprises a plurality of light fixtures arranged in a matrix on an exterior surface of the vessel; and wherein the system further comprises a user input device connected to the computer for inputting text that is transmitted for display by the matrix.

21. A system for displaying a communication from a vessel in a first location to a person in a second location that is sufficiently near to the first location that the communication is capable of being viewed by the person from the second location, the system comprising:
a computer comprising a processor, associated memory, and software for controlling the system;
a user input device connected to the computer;
a light display selection module for selecting a communication comprising a light display routine from among two or more light display routines using the user input device;
a graphical user interface that is accessible via a display communicatively connected to the computer and displays a preview of the selected light display routine;
a network for transmitting command signals;
at least one splitter for receiving the command signals from the computer via the network and transmitting the command signals;
at least one control unit for receiving the command signals from the computer via the at least one splitter and for creating and transmitting control signals; and
a plurality of light fixtures arranged in a matrix on an exterior surface of the vessel and capable of receiving the control signals from the at least one control unit; wherein the plurality of light fixtures performs the selected light display routine based on the control signals received from the at least one control unit to which the at least one light fixture is connected.

22. The system of claim 21, wherein the communication comprises a text communication, an image, an animation, a video, or a combination of two or more of the foregoing.

23. A computer-implemented method for alerting nearby vessels to the presence of a vessel to avoid collisions between the vessel and the nearby vessels, the method comprising the steps of:
(a) selecting a light matrix display routine using a user input device connected to a computer, wherein the computer comprises a processor and associated memory for storing the light matrix display routine;
(b) transmitting a command signal encoding the selected light matrix display routine via a network to at least one splitter, which further transmits the command signal to at least one control unit; and
(c) transmitting a control signal from the at least one control unit to at least one light fixture installed so that light emitted by the at least one light fixture is visible from outside the vessel, wherein the at least one light fixture displays the selected light matrix display routine to visually alert at least one nearby vessel of the vessel's presence.

24. The method of claim 23, wherein step (b) of the method is performed after the following steps:
(d) receiving data from an external source remote from the vessel; and
(e) using software installed on the computer, determining existence or absence of a trigger event; wherein if the trigger event is determined to exist, the computer creates the command signal; and wherein if the trigger event is determined to be absent, the computer does not create the command signal.

25. The method of claim 23, wherein step (b) of the method is performed after the following steps:
(f) receiving data from a sensor device aboard the vessel; and
(g) using software installed on the computer, determining existence or absence of a trigger event; wherein if the trigger event is determined to exist, the computer creates the command signal; and wherein if the trigger event is determined to be absent, the computer does not create the command signal.

26. A computer program embodied on a computer readable non-transitory medium comprising computer executable program code, which when executed by at least one processor of a device, causes the device to:
(a) select a light matrix display routine using a user input device connected to a computer, wherein the computer comprises a processor and associated memory for storing the light matrix display routine;
(b) transmit a command signal encoding the selected light matrix display routine via a network to at least one splitter, which further transmits the command signal to at least one control unit; and
(c) transmit a control signal from the at least one control unit to at least one light fixture installed so that light emitted by the at least one light fixture is visible from outside the vessel, wherein the at least one light fixture displays the selected light matrix display routine to visually alert at least one nearby vessel of the vessel's presence.
